(19) United States
(12) Patent Application Publication
(10) Pub. No.: US 2016/0171916 A1
(43) Pub. Date: Jun. 16, 2016

(54) FIELD SEQUENTIAL COLOR (FSC) DISPLAY APPARATUS AND METHOD EMPLOYING DIFFERENT SUBFRAME TEMPORAL SPREADING

(71) Applicant: Pixtronix, Inc., San Diego, CA (US)

(72) Inventors: Edward Buckley, Melrose, MA (US); Jignesh Gandhi, Burlington, MA (US)

(73) Assignee: Pixtronix, Inc., San Diego, CA (US)

(21) Appl. No.: 14/249,038

(22) Filed: Apr. 9, 2014

(51) Int. Cl. G09G 3/20; G09G 3/34

(52) U.S. Cl. CPC G09G 3/2003; G09G 3/3433; G09G 2320/062; G09G 2320/0233; G09G 2310/027

(57) ABSTRACT

This disclosure provides systems, methods, and apparatus for generating images on a display. Images are generated by displaying, for a first color, a first number of subframes at a full intensity level and a second number of subframes at reduced intensity levels. A third number of subframes of a second color are displayed at a full illumination level and a fourth number of subframes of the second color are displayed at reduced illumination levels. The number of subframes of the second color shown at reduced illumination levels is fewer than the number of subframes of the first color shown at reduced intensity levels.

### TECHNICAL FIELD

This disclosure relates to the field of imaging displays, and in particular to image formation processes for field sequential color (FSC) displays.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including an array of light modulators, a light source, and a control. The light source is capable of illuminating the array of light modulators according to a field sequential color (FSC) coded time division gray scale image formation process. The controller is capable of addressing the array of light modulators and control the illumination intensity levels of the light source. The illumination intensity level is reduced for a first number of subframes corresponding to a first color and is reduced for a second number of subframes corresponding to a second color. The first number of reduced illumination intensity level subframes is less than a total number of subframes corresponding to the first color, and the second number of reduced illumination intensity level subframes is different than the first number of reduced illumination intensity level subframes and is less than the total number of subframes corresponding to the second color.

In some implementations, the first color and second color correspond to colors of first and second subfields of an image frame, and the first number of reduced illumination intensity level subframes includes subframes generated for the first subfield of the image frame and the second number of reduced illumination intensity level subframes includes subframes generated for the second subfield of the image frame. In some such implementations, the second color corresponds to a frame specific contributing color subfield. In some implementations, the second number of reduced illumination intensity level subframes is 0. In some implementations, the second color is green and the second number of reduced illumination intensity level subframes is less than the first number of reduced illumination intensity level subframes.

In some implementations, the controller causes at least one of the subframes corresponding to the first color to be illuminated at a full intensity level for a period of time that is shorter than the amount of time it takes to address the array of light modulators with data corresponding to the at least one subframe. In some implementations, the controller causes a third number of subframes corresponding to a third color to be illuminated at reduced intensity levels, and the reduced intensity levels used to illuminate the first number of reduced illumination intensity level subframes is different than the reduced intensity levels used to illuminate the third number of reduced illumination intensity level subframes.

In some implementations, the apparatus further includes a display, a processor that is capable of communicating with the display, where the processor is capable of processing image data, and a memory device that is capable of communicating with the processor. In some such implementations, the display further includes a driver circuit capable of sending at least one signal to the display and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the display device further includes an input device capable of receiving input data and to communicate the input data to the processor.

Another innovative aspect of the subject matter described in this disclosure can be implemented in a method of forming an image frame on a display. The method includes displaying, at a first illumination level of a first color, a first number of at least partially time-weighted subframes of an image frame corresponding to the first color. The first illumination level is a maximum illumination level used for the first color in displaying the image frame. The method further includes displaying a second number of at least partially time-weighted subframes of the image frame corresponding to the first color at respective reduced illumination levels of the first color. The method also includes displaying a third number of at least partially time-weighted subframes of the image frame corresponding to a second color at a third illumination level of the second color. The third illumination level is a maximum illumination level used for the second color in displaying the image frame. A fourth number of at least partially time-weighted subframes of the image frame corresponding to the second color at respective reduced illumination levels of the second color are displayed. The number of subframes in the fourth number of subframes is different than the number of subframes in the second number of subframes.

In some implementations, the first color and second color correspond to colors of first and second subfields of an image frame, and the first number and second number of subframes include subframes generated for the first subfield of the image frame and the third number and fourth number of subframes include subframes generated for the second subfield of the image frame. In some implementations, at least one of the subframes in the first number of subframes is illuminated for a period of time that is shorter than the amount of time it takes to load data corresponding to the at least one subframe into an array of light modulators used to display the at least one subframe.

In some implementations, the second color corresponds to a frame specific contributing color subfield. In some implementations, the fourth number of subframes is 0. In some implementations, the second color is green.

In some implementations, the method further includes displaying a fifth number of at least partially time-weighted subframes of the image frame corresponding to a third color at respective reduced illumination levels of the third color. The number of subframes in the fifth number of subframes is different than the number of subframes in the second number of subframes.

Another innovative aspect of the subject matter described in this disclosure can be implemented in a computer readable medium storing computer executable instructions, which when executed, cause a processor to display, at a first illumination level of a first color, a first number of at least partially time-weighted subframes of an image frame corresponding to the first color. The first illumination level is a maximum illumination level used for the first color in displaying the image frame. The instructions further cause the processor to display a second number of at least partially time-weighted subframes of the image frame corresponding to the first color at respective reduced illumination levels of the first color. The instructions also cause the processor to display a third number of at least partially time-weighted subframes of the image frame corresponding to a second color at a third illumination level of the second color. The third illumination level is a maximum illumination level used for the second color in displaying the image frame. The instructions further cause the processor to display a fourth number of at least partially time-weighted subframes of the image frame corresponding to the second color at respective reduced illumination levels of the second color. The number of subframes in the fourth number of subframes is different than the number of subframes in the second number of subframes.

In some implementations, the first color and second color correspond to colors of first and second subfields of an image frame, and the first number and second number of subframes include subframes generated for the first subfield of the image frame and the third number and fourth number of subframes include subframes generated for the second subfield of the image frame. In some implementations, the second color corresponds to a frame specific contributing color subfield. In some implementations, at least one of the subframes in the first number of subframes is illuminated for a period of time that is shorter than the amount of time it takes to load data corresponding to the at least one subframe into an array of light modulators used to display the at least one subframe.

Details of one or more implementations of the subject matter described in this specification are set forth in the accompanying drawings and the description below. Although the examples provided in this summary are primarily described in terms of electromechanical systems (EMS) based displays, the concepts provided herein may apply to other types of displays, such as liquid crystal displays (LCDs), organic light-emitting diode (OLED) displays, electrophoretic displays, and field emission displays, as well as to other non-display EMS devices, such as EMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use as, for example, the control logic in the display apparatus shown in FIG. 3.

FIG. 5 shows flow diagram of an example method for generating an image on a display using the control logic shown in FIG. 4.

FIG. 6 shows a timing diagram of an example output sequence.

FIG. 7 shows a flow diagram of an example process of forming an image on a display.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In a time division gray scale, field sequential color (FSC) display, power efficiency can be improved by illuminating even the lowest weighted subframes for at least as long as it takes to load the data associated with a subsequent subframe into the display. These lower weighted subframes are shown for increased time durations at reduced illumination intensity levels such that the net light output for the subframe is not changed.

However, this “time-stretching” of lower weighted subframes can, in some cases, introduce flicker artifacts in certain color subfields. As such, in some implementations, the number of subframes that are time-stretched is set on a color subfield-by-color subfield basis, such that at least one color subfield is displayed using fewer time-stretched subframes that are illuminated at reduced intensity levels than are used in displaying another color subfield. For example, green subfields and subfields associated with frame specific composite colors (FSCCs) may be displayed using fewer time-stretched subframes, with more subframes being displayed at full intensity for shorter periods of time. In some implementations, the number of subframes stretched for the FSCC subfield can be determined dynamically based on the color composition of the FSCC used for the image frame. Using these shorter duration subframes helps reduce the risk of flicker perception for these colors. In addition, variation of the subframe duration may help to counteract display artifacts associated with digital gray scale displays, such as dynamic false contouring (DFC), or the color break-up (CBU) effect associated with FSC displays.

Particular implementations of the subject matter described in this disclosure can be implemented to realize one or more of the following potential advantages. By stretching out the length of certain subframes of appropriate colors, a display can operate more efficiently, reducing power consumption and increasing battery life, which is especially important for mobile devices. At the same, by tailoring such subframe stretching based on the color of the subframe, this energy efficiency can be obtained without introducing additional flicker artifacts. Thus, a desirable balance is struck between image quality and power consumption. Finally, stretching out the subframe time (whilst simultaneously reducing the display intensity such that the average intensity is maintained), may confer advantages in reduction of DFC or CBU.

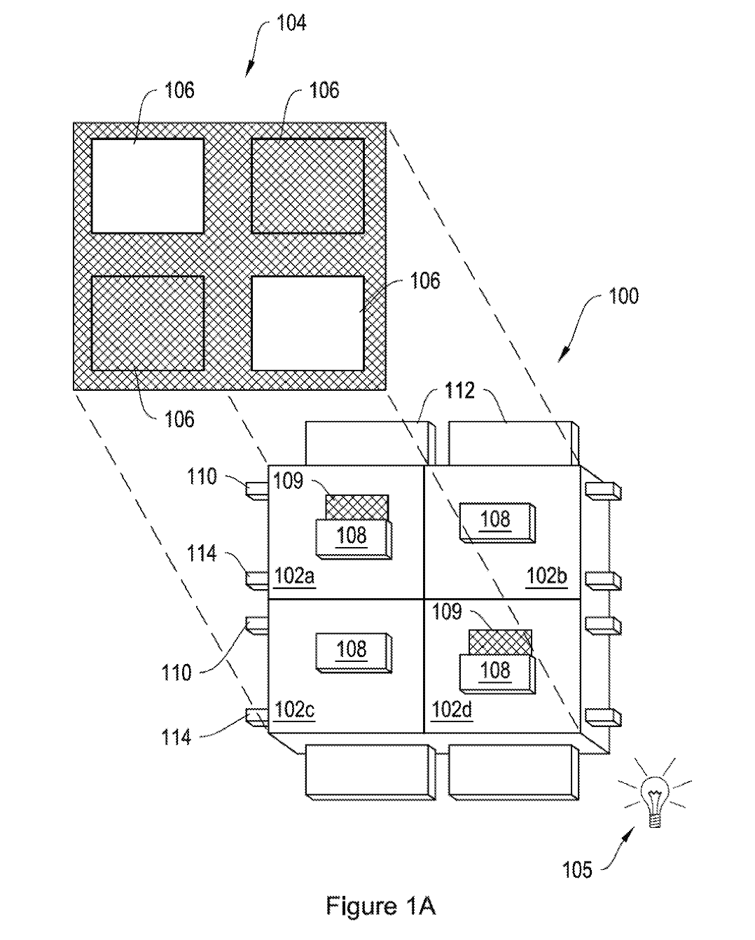

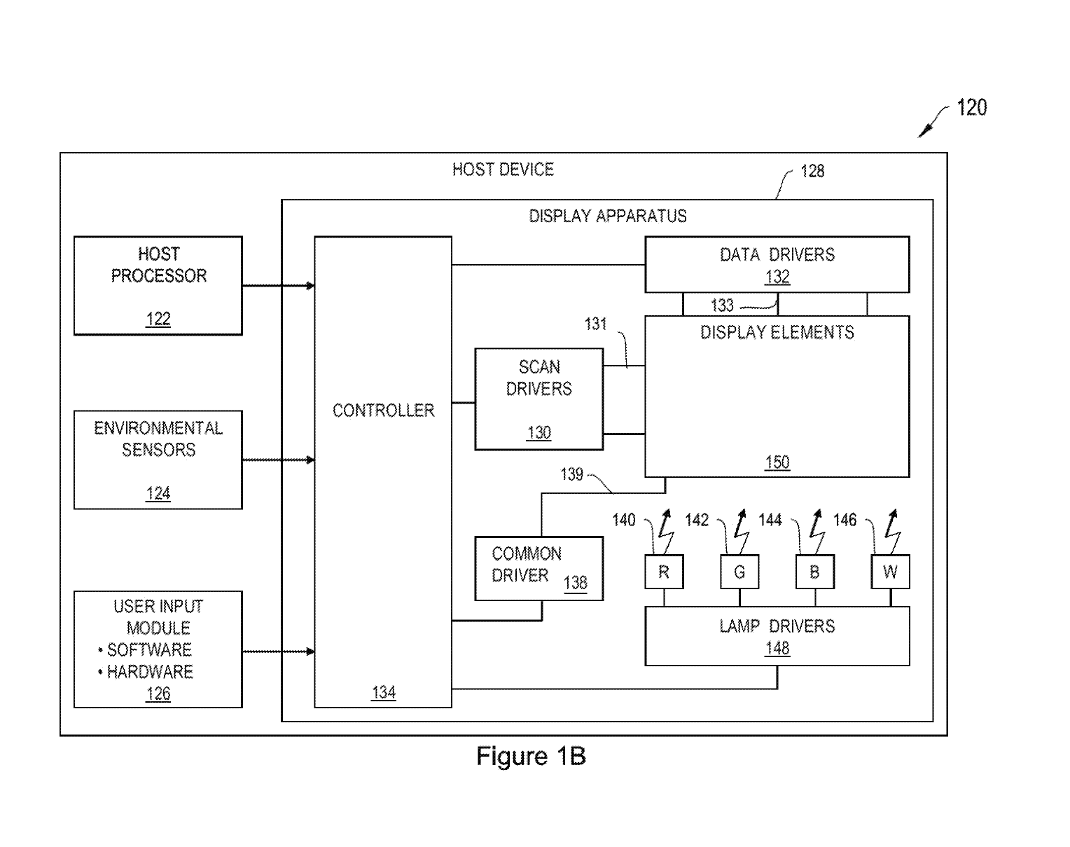

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent or glass substrates to facilitate a sandwich assembly arrangement where one substrate, containing the light modulators, is positioned over the backlight.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages results in the electrostatic driven movement of the shutters 108.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 conveys the personal preferences of the user to the controller 134, either directly, or via the host processor 122. In some implementations, the user input module 126 is controlled by software in which a user programs personal preferences, for example, color, contrast, power, brightness and content preferences. In some other implementations, these preferences are input to the host device 120 using hardware, such as a button, switch or dial, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

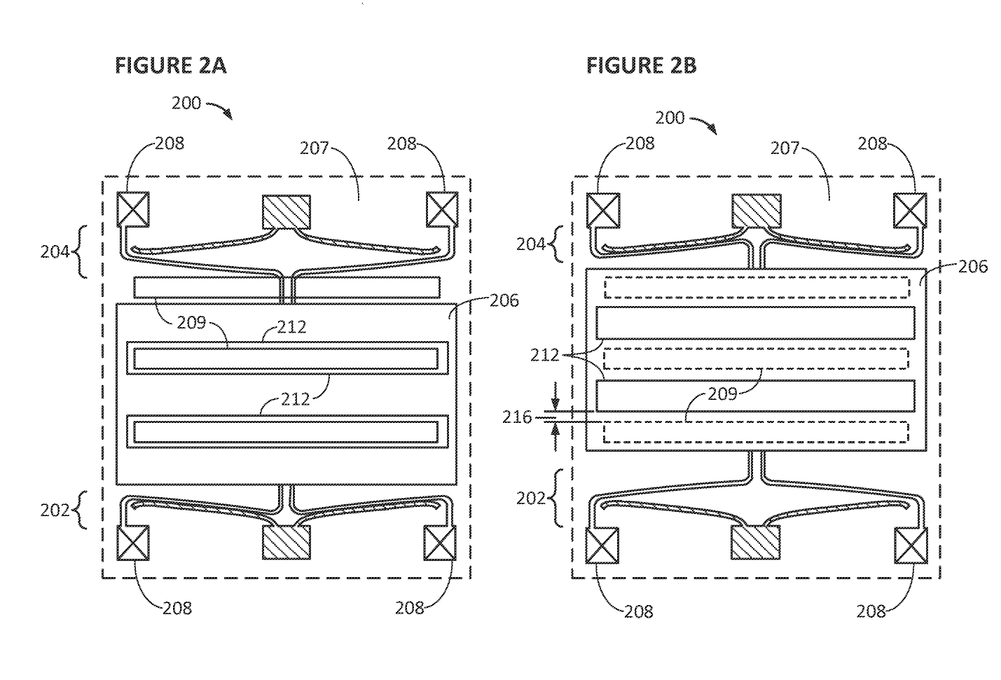

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

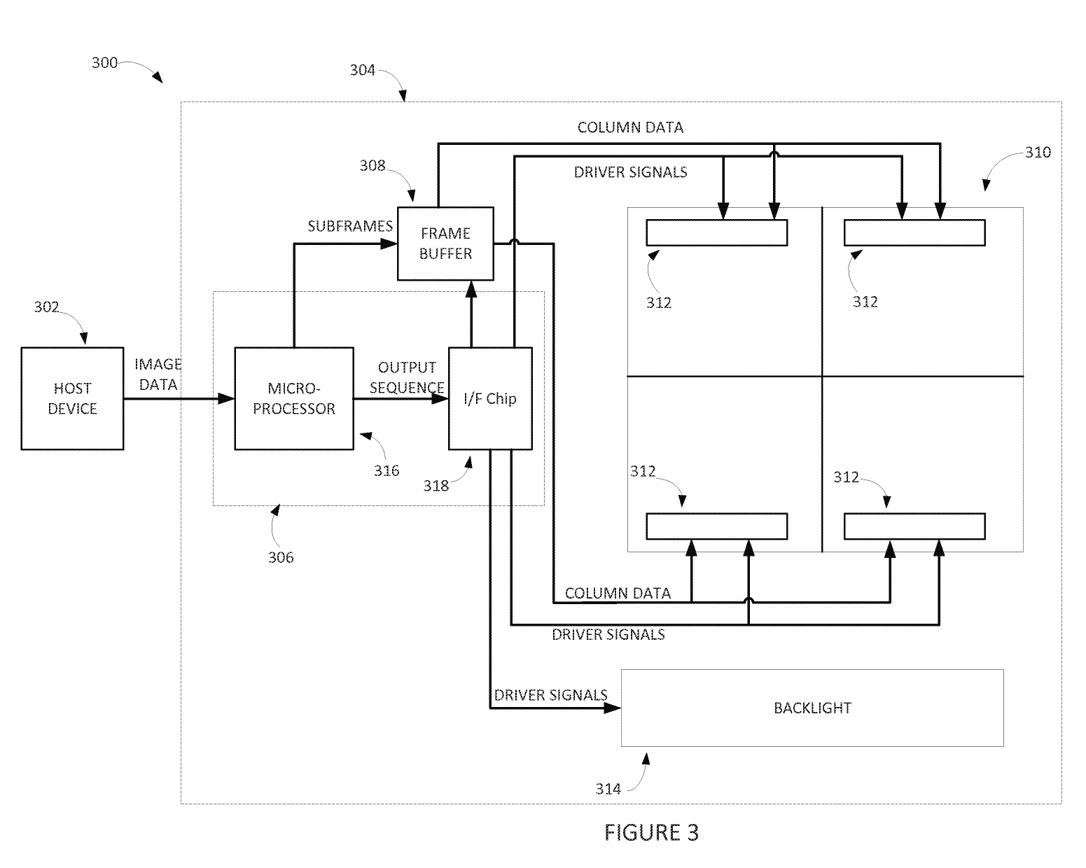

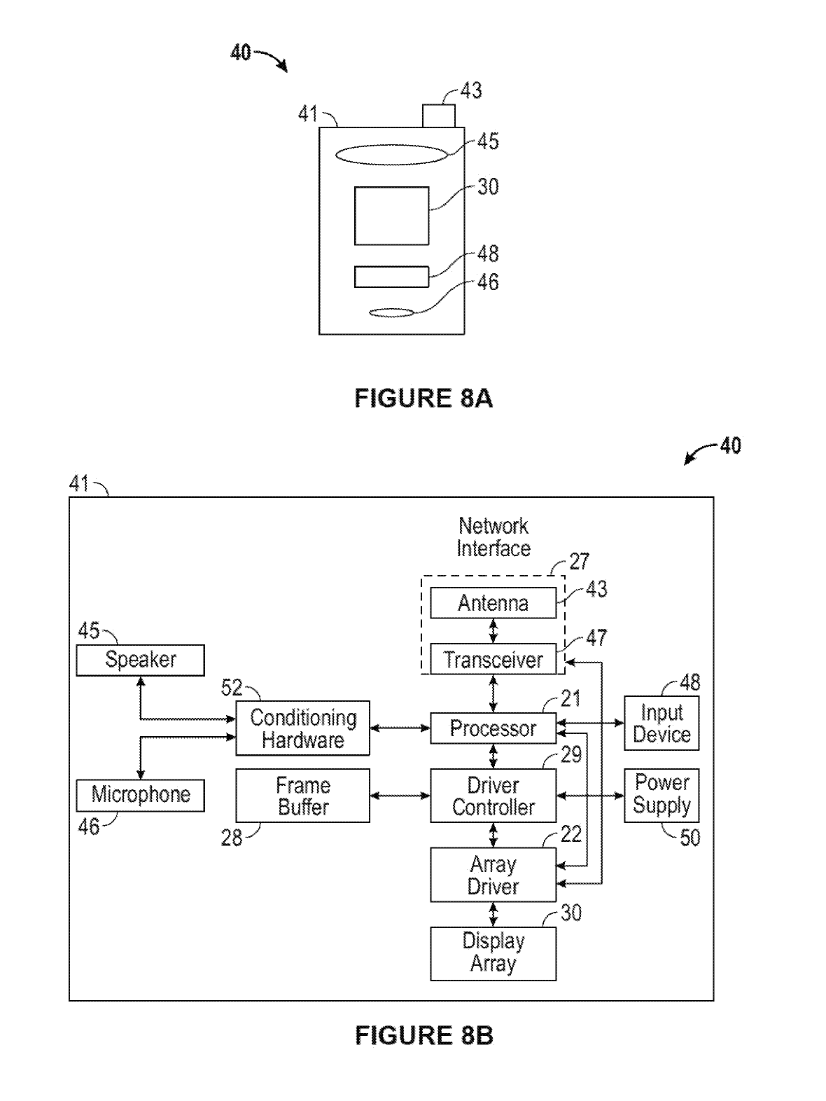

FIG. 3 shows a block diagram of an example display apparatus 300. The display apparatus 300 includes a host device 302 and a display module 304. The host device 302 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 40 shown in FIGS. 8A and 8B below. In general, the host device 302 serves as a source for image data to be displayed on the display module 304.

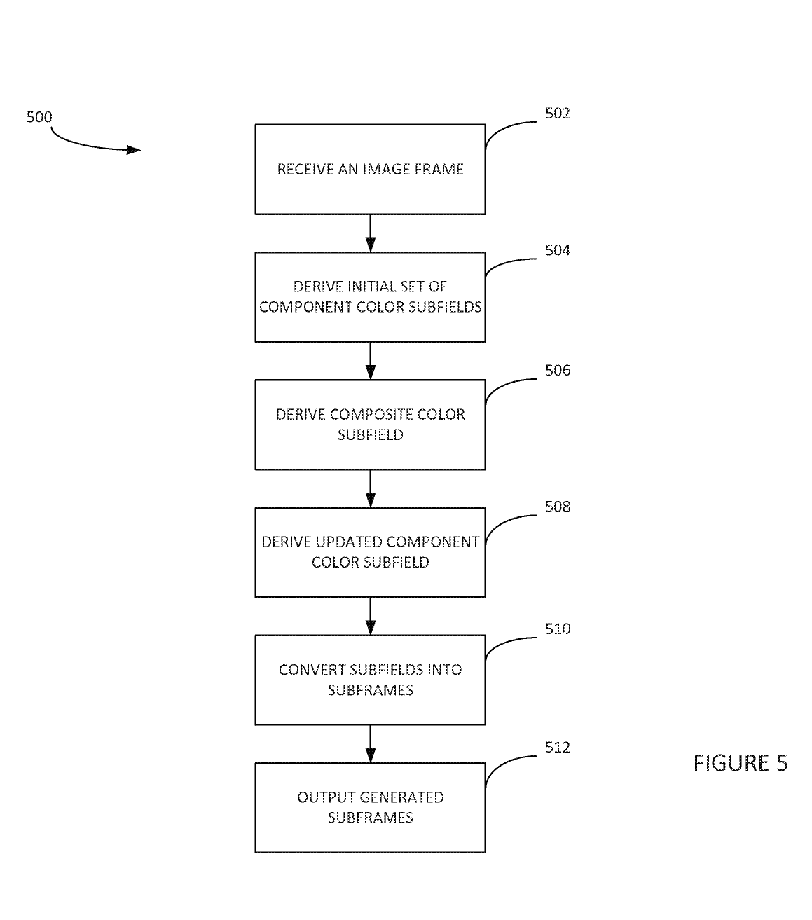

The display module 304 further includes control logic 306, a frame buffer 308, an array of display elements 310, display drivers 312 and a backlight 314. In general, the control logic 306 serves to process image data received from the host device 302 and controls the display drivers 312, array of display elements 310 and backlight 314 to together produce the images encoded in the image data. The control logic 306, frame buffer 308, array of display elements 310, and display drivers 312 shown in FIG. 3 can be similar, in some implementations, to the driver controller 29, frame buffer 28, display array 30, and array drivers 22 shown in FIGS. 8A and 8B, below. The functionality of the control logic 306 is described further below in relation to FIGS. 5-7.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 318 can be capable of carrying out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 8B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The frame buffer 308 can be any volatile or non-volatile integrated circuit memory, such as DRAM, high-speed cache memory, or flash memory (for example, the frame buffer 308 can be similar to the frame buffer 28 shown in FIG. 8B). In some other implementations, the interface chip 318 causes the frame buffer 308 to output data signals directly to the display drivers 312. The frame buffer 308 has sufficient capacity to store color subfield data and subframe data associated with at least one image frame. In some implementations, the frame buffer 308 has sufficient capacity to store color subfield data and subframe data associated with a single image frame. In some other implementations, the frame buffer 308 has sufficient capacity to store color subfield data and subframe data associated with at least two image frames. Such extra memory capacity allows for additional processing by the microprocessor 316 of image data associated with a more recently received image frame while a previously received image frame is being displayed via the array of display elements 310.

In some implementations, the display module 304 includes multiple memory devices. For example, the display module 304 may include one memory device, such as a memory directly associated with the microprocessor 316, for storing subfield data, and the frame buffer 308 is reserved for storage of subframe data.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, as shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 314, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 314 can include a light guide, one or more light sources (such as LEDs), and light source drivers. The light sources can include light sources of multiple colors, such as red, green, blue, and in some implementations white. The light source drivers are capable of individually driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

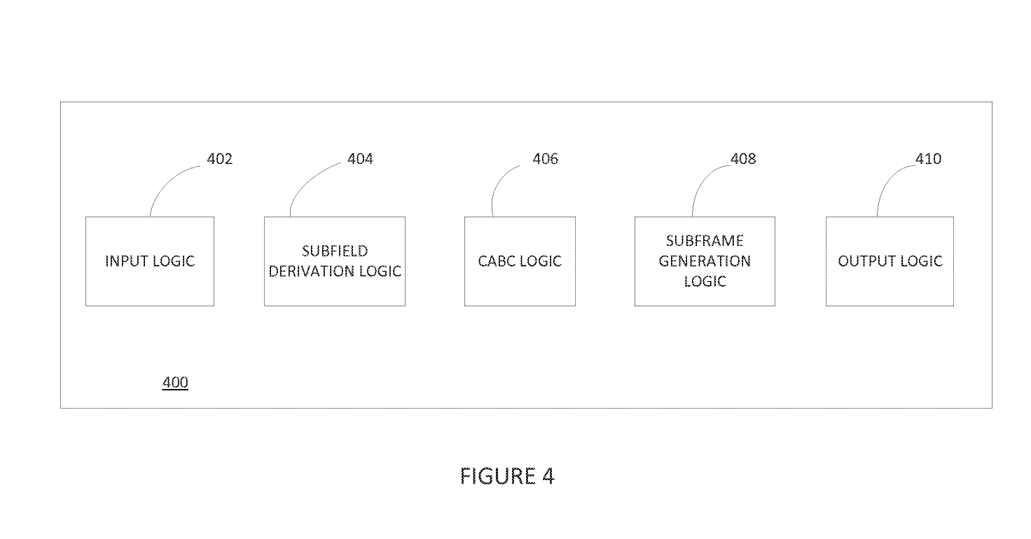

FIG. 4 shows a block diagram of example control logic 400 suitable for use as, for example, the control logic 306 in the display apparatus 300 shown in FIG. 3. More particularly, FIG. 4 shows a block diagram of functional modules executed by the microprocessor 316 and the I/F Chip 318. Each functional module can be implemented as software in the form of computer executable instructions stored on a tangible computer readable medium, which can be executed by the microprocessor 316 and/or as logic circuitry incorporated into the I/F Chip 318. The control logic 400 includes subfield derivation logic 402, subframe generation logic 404, and output logic 406. While shown as separate functional modules in FIG. 4, in some implementations, the functionality of two or more of the modules may be combined into one or more larger, more comprehensive modules. Together the components of the control logic 400 function to carry out a method for generating an image on a display.

FIG. 5 shows flow diagram of an example method 500 for generating an image on a display using the control logic 400 shown in FIG. 4. The method 500 includes receiving an image frame (stage 502), deriving an initial set of component color subfields (stage 504), deriving a composite color subfield (stage 506), deriving updated component color subfields (stage 508), converting the derived subfields into subframes (stage 510) and outputting the subframes (stage 512) to display the image.

The method 500 begins with the subfield derivation logic 402 receiving data associated with an image frame (stage 502). Typically, such image data is obtained as a stream of intensity values for the red, green, and blue components of each pixel in the image frame. The intensity values typically are received as binary numbers.

The subfield derivation logic 402 can derive and store an initial set of component color subfields for the image frame based on the received image data (stage 504). Each color subfield includes for each pixel in the display an intensity value indicating the amount of light to be transmitted by that pixel, for that color, to form the image frame. A component color subfield refers to a subfield associated with a color that forms one of the vertices of the color gamut (represented in the x, y or other color space) reproduced by the display. For example, in the CIE 1931 color space, the component colors would be red, green, and blue.

In some implementations, the subfield derivation logic 402 derives the initial set of component color subfields (stage 504) by segregating the pixel intensity values for each primary color represented in the received image data (i.e., red, green, and blue). In some implementations, one or more image preprocessing operations, such as gamma correction and dithering, also may be carried out by the subfield derivation logic 402 prior to, or in the process of, deriving the initial set of component color subframes (stage 504).

The subfield derivation logic 402 can derive a composite color subfield (stage 506) based on the initial set of component color subframes. A composite color subfield is a subfield associated with a composite color. Examples of such composite colors include white, yellow, cyan, magenta, orange, or any other color formed by combining two or more of a display's component colors to equal or varying degrees. In some implementations, the composite color is selected for each image frame base on the contents of that image and/or one or more previous image frames. In general, displaying an image using a composite color can help mitigate color break-up (CBU) image artifacts and, in some cases, can reduce the power consumed by the display in generating images.

In some implementations in which the composite color subfield is a white subfield, the subfield derivation logic 402 derives the composite color subfield by identifying for each pixel the minimum of the intensity values associated with that pixel in the component color subfields. For example, consider a pixel having component color pixel intensity values of {R, G, B}={150, 100, 50}, where R corresponds to red, G corresponds to green, and B corresponds to blue. For such a pixel, the subfield derivation logic 402 would set the intensity value for the pixel in a white composite color subfield to 50. In some other implementations, the subfield derivation logic 402 sets the intensity value for a pixel in the composite color subfield to a fraction (such as 25%, 33%, 50%, 60%, 75%, etc.) of the minimum of the component color intensity values for the pixel.

The subfield derivation logic 402 can derive an updated set of component color subfields (stage 508) based on the derived composite color subfield. More particularly, the subfield derivation logic 402 reduces the intensity values in the component color subfields to account for any light energy being output through the composite color subfield. For example, for the pixel discussed above with input pixel intensity values of {R, G, B}={150, 100, 50}, and a composite color intensity value {W}={50}, the subfield derivation logic 402 can reduce the intensity values in each of the component color subfields by 50. The resulting set of intensity values for the pixel in each of the four subfields is {R, G, B, W}={100, 50, 0, 50}.

In some implementations, additional processing may be carried out on a derived subfield prior to generation of subframes. For example, in some implementations, the CABC logic 406 is configured to generate CABC-adjusted subfields. In implementing CABC, pixel intensity values associated with a subfield are scaled up while the output intensity of the backlight for illuminating that subfield is scaled down. The scaling down of the output intensity of the backlight improves the power efficiency of the display apparatus. Moreover, this improved power efficiency is achieved while substantially maintaining image quality. The output intensity of the backlight is typically scaled down by a factor referred to herein as a light source scaling factor F. This light source scaling factor F can be determined in several ways. In particular, two example scaling factors F₁ and F₂ are discussed below.

In some implementations, the light source scaling factor F₁ can be determined using pixel intensity values before and after the application of CABC. In some such implementations, the CABC logic 406 can utilize a CABC lookup table (LUT) to determine CABC-adjusted pixel intensity values. In some such implementations, the CABC-LUT can be populated with a range of CABC-adjusted pixel intensity values for a corresponding range of pixel intensity values. The CABC-adjusted pixel intensity values also may be generated using a CABC-function, such as a polynomial, that can produce a CABC-adjusted pixel intensity value for a given pixel intensity value. The CABC-function can be linear, non-linear, or part linear and part non-linear. Both the CABC-LUT and the CABC-function can ensure that the CABC-adjusted pixel intensity values do not exceed the maximum intensity value that can be displayed in the subfield. For example, if 8-bits are being used to represent a pixel intensity value, then the maximum pixel intensity value cannot exceed 255. Thus, the CABC-LUT and the CABC-function can be configured to ensure that the CABC-adjusted pixel intensity values do not exceed the value 255. In some implementations, the CABC logic 406 can include multiple CABC-LUTs or CABC-functions. The CABC logic 406 selects a CABC-LUT or CABC-function based on one or more characteristics of the input subfield, such as the average pixel intensity value, the maximum intensity value, the median pixel intensity value, etc.

The pixel intensity values prior to applying CABC and the CABC-adjusted pixel intensity values can be used to determine a light source scaling factor F₁ for scaling down the output intensity of the backlight. For example, in some implementations, a scaling factor F₁ can be a ratio of the average pixel intensity value of the derived subfield (i.e., before applying CABC) over the average pixel intensity value of the CABC-adjusted subfield. Typically, the scaling factor F₁ can be less than or equal to one, and can be passed to the output logic 410.

In some implementations, the light source scaling factor F₂ can be determined using the pixel intensity values of the derived subfield itself. In some implementations, the scaling factor F₂ for each color is the same and is derived by taking the minimum of the scaling factors F₂ for each color channel. In some such implementations, the derived subfield can scaled up and the output intensity of the backlight can be scaled down by the same scaling factor, F₂. For example, the CABC-adjusted subfield can be generated by identifying a highest pixel intensity value in a subfield and scaling all the pixel values in the subfield such that the pixel value of the pixel with the highest intensity level is equal to the maximum intensity value used by the display. For example, if the pixel intensity values for a color subfield range from 0 to 255, and the highest pixel intensity value in that subfield is 150, then the CABC logic 406 determines the light source scaling factor, F₂, as a ratio of the highest pixel intensity value (150) over the maximum intensity value (255). That is, the light source scaling factor F₂ equals 150/255. The CABC logic 406 multiplies all the pixel intensity values in the color subfield by the inverse of the scaling factor F₂ to generate CABC-adjusted pixel intensity values. For example, if a pixel intensity value is equal to 100, then the CABC logic 406 multiplies 100 by 1/F₂ (or, using the above example, by 255/150) to generate the corresponding CABC-adjusted pixel intensity value. In this manner, all the pixel intensity values in the subfield are scaled up by the inverse of the light source scaling factor F₂, and the output intensity of the backlight is scaled down by the light source scaling factor F₂. As mentioned above, the scaling down of the output intensity of the backlight improves the power efficiency of the display apparatus. The CABC-adjusted subfield, scaled up by the scaling factor F₂, can be processed by the subframe generation logic 408.

In some implementations, the scaling factor F may be determined differently than set forth above. For example, in some implementations, the numerator of the ratio representing the scaling factor F discussed above, can be an average or another function of some or all pixel intensity values in the subfield instead of the highest of all pixel values. In some implementations, the denominator can be a value higher than the maximum intensity value a pixel can assume in the subfield. In some other implementations, the scaling factor F may be an arbitrary value independent of the pixel intensity values in the subfield.

Referring back to FIG. 5, the subframe generation logic 408 (shown in FIG. 4) can be implemented to convert the derived subfields into sets of subframes (stage 510). Each subframe corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 310.

In some implementations, the subframe generation logic 408 uses a code word lookup table (LUT) to generate the subframes (stage 510). In some implementations the code word LUT stores a series of binary values referred to as code words that indicate a series of display element states that result in a given pixel intensity value. The value of each digit in the code word indicates a display element state (for example, light or dark) and the position of the digit in the code word represents the weight that is to be attributed to the state. In some implementations, the weights are assigned to each digit in the code word such that each digit is assigned a weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes (stage 510), the subframe generation logic 408 obtains code words for all pixels in a color subfield. The subframe generation logic 408 can aggregate the digits in each of the respective positions in the code words for each pixel together into subframes. For example, the digits in the first position of each code word for each pixel are aggregated into a first subframe. The digits in the second position of each code word for each pixel are aggregated into a second subframe, and so forth. The subframes, once generated, are stored in the frame buffer 308 shown in FIG. 3.

In some other implementations, particularly for implementations using light modulators capable of achieving one or more partially transmissive states, the code word LUT may store code words using base-3, base-4, base-10, or some other base number scheme.

The output logic 410 of the control logic 400 (shown in FIG. 4) can output the generated subframes (stage 512) to display the received image frame. Similar to as described above in relation to FIG. 3 with respect to the I/F chip 318, the output logic 410 outputs cause each subframe to be loaded into the array of display elements 310 (shown in FIG. 3) and illuminated according to an output sequence. In some implementations, the output sequence is capable of being configured, and may be modified based on user preferences, the content of image data being displayed, external environmental factors, etc.

In certain time division gray scale displays, the amount of time some lower weighted subframes would be displayed, if displayed at full backlight intensity, would be less than the amount of time it takes for a subsequent subframe to be loaded into the display. The time interval between the illumination of these lower weighted ceasing and the loading of the next subframe completing is, to some extent, wasted. Moreover, for backlights with LEDs having nonlinear current versus light output curve, displaying subframes for such a short period of time at a high backlight intensity is less energy efficient than displaying the same subframes for longer periods of time (up to the amount of time it takes to address the display for a subsequent subframe) at a lower backlight intensity. Thus extending the duration for which such subframes are illuminated to match the subframe loading time can make for a more energy efficient display. However, doing so can introduce additional image artifacts, such as flicker.

To take advantage of possible energy efficiencies associated with illuminating lower weighted subframes for longer periods of time at lower backlight intensities, without introducing flicker, the illumination period for each subframe can be tailored based on its corresponding color and weight. For example, the human visual system (HVS) is more sensitive to flicker artifacts in green light than in blue or red light. Hence the critical flicker frequency (CFF) (i.e. the lowest frequency at which the HVS begins to perceive flicker) for the green color can often approach, or exceed, the frame rate of the display and therefore cause flicker artifacts. Since flicker perception increases with illumination time, the degree to which the illumination time for lower weighted green subframes can be “stretched” is less than the degree to which lower weighted red and blue subframes can be stretched.

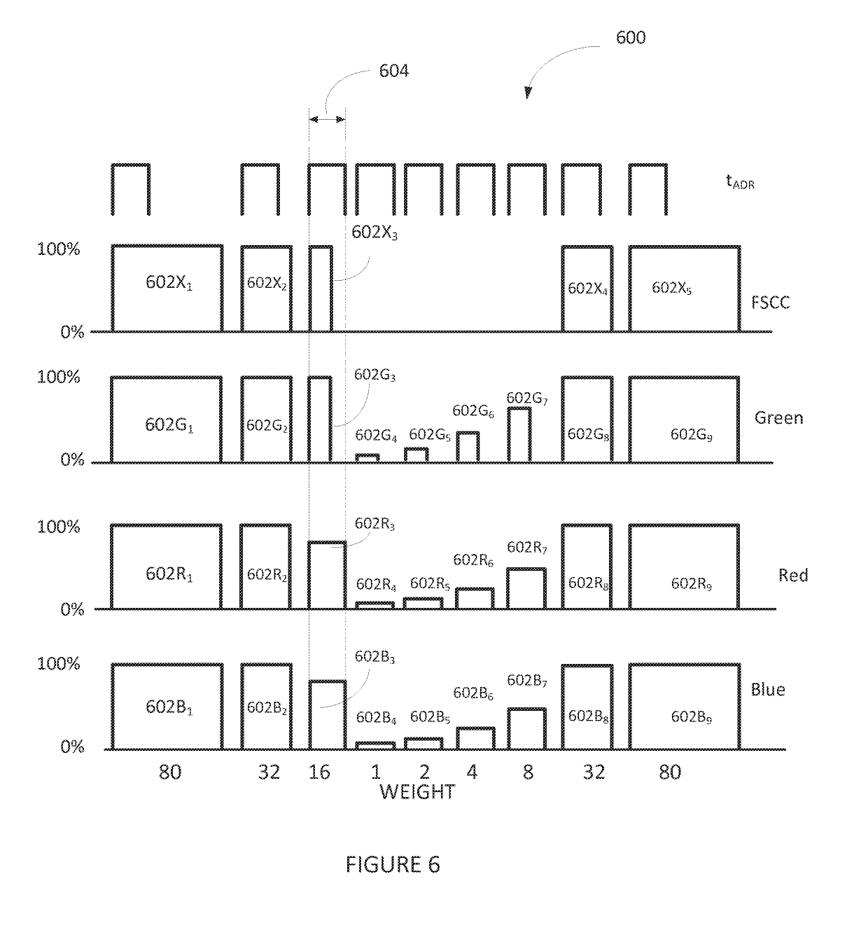

FIG. 6 is a timing diagram of an output sequence 600. The output sequence 600 can be implemented by the output logic 410 of the controller 400 shown in FIG. 4 to improve display energy efficiency without unduly increasing flicker artifacts. Generally, the timing diagram 600 corresponds to an output sequence that reduces the intensity at which certain lower weighted subframes are illuminated, while at the same time increasing the length for which those subframes are illuminated, thereby increasing energy efficiency for LEDs which exhibit a nonlinear current versus light output characteristic.

The timing diagram shows the relative illumination level and amount of time each of 32 subframes (generally “subframes 602”), including 9 red subframes 602R₁-602R₉, 9 green subframes 602G₁-602G₉, 9 blue subframes 602B₁-602B₉, and 5 subframes 602X₁-602X₅ for a frame-specific composite color (FSCC) (i.e., a composite color selected for use in displaying that image frame). The duration of each subframe 602 is depicted by its respective width, while its intensity level is depicted by its height. Together, the duration and intensity combine to generate a desired weight (shown at the bottom of the timing diagram).

In some implementations, the subframes 602 can be output in order, one row at a time, from left to right or right to left. In some implementations, the subframes 602 can be output one column at a time from top to bottom or bottom to top. In some implementations, the subframes are output in another order, such as, for example, a random or pseudo random order, or an order selected to mitigate one or more image artifacts.

The timing diagram 600 also indicates the amount of time t_{ADR} 604 it takes to load each subframe into a display (the “addressing time 604”). As can be seen, the higher weighted subframes, such as subframes 602 with weights of 80 and 32, like subframes 602R1, 602R2, 602R8 and 602R9, even if illuminated at full intensity, have durations that are longer than the addressing time 604. In contrast, the subframes 602 having weights of 16 or less, if illuminated at full intensity, such as subframes 602G₃ and 602X₃, have durations that are less than the addressing time 604. As such, for the red and blue lower weighted subframes 602R₃-602R₇ and 602B₃-602B₇, instead of continually reducing the duration of each subframe to reduce its weight, beginning with the subframes of weight 16 and lower, a reduction in weight is effected through a reduction in illumination level, while retaining the duration of each subframe equal to the addressing time 604. This allows the red and blue LEDs of the display backlight 314 (shown in FIG. 3) to be illuminated at more efficient points on their power curve.

However, as increasing the duration of the similarly weighted green subframes 602G₃-602G₇ could potentially increase the likelihood of flicker perception, the durations of the subframes 602G₃-602G₇ are kept shorter. For example, the green subframe of weight 16, i.e., subframe 602G₃, is illuminated at full intensity for a period that is shorter than the addressing time 604. As the weights of the subframes continue to decrease, for example for subframes 602G₄-602G₇, the duration of each subframe is kept about the same as the duration of subframe 602G₃, but the intensity levels are decreased to effect the reduction in weight. By keeping the subframe durations relatively short, the output logic 410 is able to ensure that the CFF of green is below the frame rate of the display. The CFFs of red and blue are lower than that of green, thereby allowing greater stretching of the durations which lower weighted red and blue subframes are illuminated.

In the timing diagram 600, the weight 16 subframe of the FSCC channel 602X₃, which may vary from frame to frame, is shown as being displayed at a full illumination level for a duration that is less than the addressing time 604. In some implementations, this subframe 602X₃, is shown at full intensity for a shorter duration when the FSCC includes more than a de minis amount of green. If, instead, the FSCC were magenta, the output logic 410 may increase the duration of the subframe 602X₃ to match the addressing time, as the risk of flicker perception is not significantly increased.

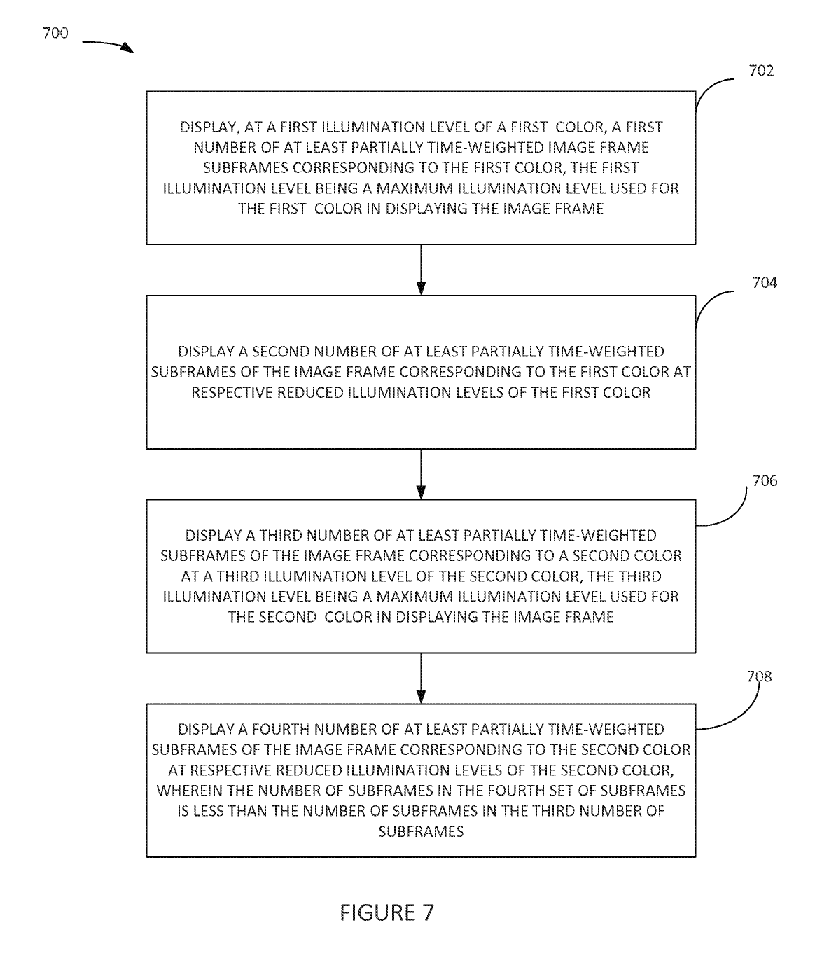

FIG. 7 shows a flow diagram of a process 700 of forming an image frame on a display. In some implementations, the process 700 can correspond to the execution by the control logic 400 (shown in FIG. 4) of the output sequence depicted in the timing diagram 600 shown in FIG. 6.

The process 700 includes displaying, at a first illumination level of a first color, a first number of at least partially time-weighted image frame subframes corresponding to the first color, where the first illumination level is a maximum illumination level used for the first color in displaying the image frame (stage 702). As discussed above in relation to FIG. 6, in the output sequence described above, higher weighted subframes for each color are shown at a full intensity level. For example, for the red and blue color subfields, four subframes of each color (i.e., subframes 602R₁, 602R₂, 602R₈, and 602R₉, and subframes 602B₁, 602B₂, 602B₈, and 602B₉) are shown at full intensity.

In some situations, this full intensity level is the maximum output intensity the display is capable of generating for a given primary color. In other situations, the full intensity level is instead the maximum intensity level used for that primary color for that image frame. The relationship between the full intensity level and the maximum possible intensity level can depend, for example, on whether the subfields derived for the image frame were processed by CABC logic (such as the CABC logic 406 shown in FIG. 4). As discussed above, as a result of processing by the CABC logic 406 shown in FIG. 4, the output logic 410 (also shown in FIG. 4) may be instructed to reduce the maximum light source intensity level for a given color of an image frame. At the same time, the CABC logic 406 increases the intensity values of the respective pixels in the corresponding color subfield. In such situations, the maximum intensity level of a primary color for an image frame may be the CABC-reduced color intensity level for that image frame.

The process 700 further includes displaying a second number of at least partially time-weighted subframes of the image frame corresponding to the first color at respective reduced illumination levels of the first color (stage 704). As discussed above in relation to FIG. 6, after the illumination time for certain lower weighted subframes at the full intensity level falls below the amount of time needed to load the data associated with the subframe into the display, the output logic 410 causes the lower weighted subframes to be displayed for longer durations at reduced illumination intensities. For example, for the red and blue subframes shown in the timing diagram 600, five subframes of each color (i.e., subframes 602R₃, 602R₄, 602R₅, 602R₆, and 602R₇, and subframes 602B₃, 602B₄, 602B₅, 602B₆, and 602B₇) are shown at respective reduced intensity levels.

The process 700 also includes displaying a third number of at least partially time-weighted subframes of the image frame corresponding to a second color at a third illumination level of the second color, the third illumination level being a maximum illumination level used for the second color in displaying the image frame. For example, the output sequence depicted in FIG. 6 shows five subframes of green and the FSCC subfields shown at full intensity. Note that this in contrast to the red and blue colored subfields, in which only four subframes were shown at full intensity.

Additionally, the process 700 also includes displaying a fourth number of at least partially time-weighted subframes of the image frame corresponding to the second color at respective reduced illumination levels of the second color, where the number of subframes in the fourth set of subframes is less than the number of subframes in the third number of subframes (stage 708). Referring again to the timing diagram 600 shown in FIG. 6, only four subframes corresponding to the color green are shown at reduced illumination levels (in contrast to five for the red and blue subfields), and no subframes of the FSCC subfield are shown at a reduced intensity level.

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an array of light modulators;
a light source, wherein the light source is configured to illuminate the array of light modulators according to a field sequential color (FSC) coded time division gray scale image formation process; and
a controller configured to:
address the array of light modulators; and
control the illumination intensity levels of the light source, wherein the illumination intensity level is reduced for a first number of subframes corresponding to a first color and is reduced for a second number of subframes corresponding to a second color, and
wherein the first number of reduced illumination intensity level subframes is less than a total number of subframes corresponding to the first color, and the second number of reduced illumination intensity level subframes is different than the first number of reduced illumination intensity level subframes and is less than the total number of subframes corresponding to the second color.

2. The apparatus of claim 1, wherein:
the first color and second color correspond to colors of first and second subfields of an image frame, and the first number of reduced illumination intensity level subframes includes subframes generated for the first subfield of the image frame and the second number of reduced illumination intensity level subframes includes subframes generated for the second subfield of the image frame.

3. The apparatus of claim 2, wherein the second color corresponds to a frame specific contributing color subfield.

4. The apparatus of claim 3, wherein the second number of reduced illumination intensity level subframes is 0.

5. The apparatus of claim 1, wherein the second color is green and the second number of reduced illumination intensity level subframes is less than the first number of reduced illumination intensity level subframes.

6. The apparatus of claim 1, wherein the controller causes at least one of the subframes corresponding to the first color to be illuminated at a full intensity level for a period of time that is shorter than the amount of time it takes to address the array of light modulators with data corresponding to the at least one subframe.

7. The apparatus of claim 1, wherein the controller causes a third number of subframes corresponding to a third color to be illuminated at reduced intensity levels, and the reduced intensity levels used to illuminate the first number of reduced illumination intensity level subframes is different than the reduced intensity levels used to illuminate the third number of reduced illumination intensity level subframes.

8. The apparatus of claim 1, further comprising:
a display including:
the array of light modulators and one or more driver circuits,
a processor that is capable of communicating with the display, the processor being capable of processing image data; and
a memory device that is capable of communicating with the processor.

9. The apparatus of claim 8, the display further including:
a driver circuit capable of sending at least one signal to the display; and
a controller capable of sending at least a portion of the image data to the driver circuit.

10. The apparatus of claim 8, further including:
an image source module capable of sending the image data to the processor, wherein the image source module comprises at least one of a receiver, transceiver, and transmitter.

11. The apparatus of claim 8, the display device further including:
an input device capable of receiving input data and to communicate the input data to the processor.

12. A method of forming an image frame on a display, comprising:
displaying, at a first illumination level of a first color, a first number of at least partially time-weighted subframes of an image frame corresponding to the first color, the first illumination level being a maximum illumination level used for the first color in displaying the image frame;
displaying a second number of at least partially time-weighted subframes of the image frame corresponding to the first color at respective reduced illumination levels of the first color;
displaying a third number of at least partially time-weighted subframes of the image frame corresponding to a second color at a third illumination level of the second color, the third illumination level being a maximum illumination level used for the second color in displaying the image frame; and
displaying a fourth number of at least partially time-weighted subframes of the image frame corresponding to the second color at respective reduced illumination levels of the second color, wherein the number of subframes in the fourth number of subframes is different than the number of subframes in the second number of subframes.

13. The method of claim 12, wherein the first color and second color correspond to colors of first and second subfields of an image frame, and the first number and second number of subframes include subframes generated for the first subfield of the image frame and the third number and fourth number of subframes include subframes generated for the second subfield of the image frame.

14. The method of claim 13, wherein the second color corresponds to a frame specific contributing color subfield.

15. The method of claim 14, wherein the fourth number of subframes is 0.

16. The method of claim 12, wherein the second color is green.

17. The method of claim 12, wherein at least one of the subframes in the first number of subframes is illuminated for a period of time that is shorter than the amount of time it takes to load data corresponding to the at least one subframe into an array of light modulators used to display the at least one subframe.

18. The method of claim 12, further comprising displaying a fifth number of at least partially time-weighted subframes of the image frame corresponding to a third color at respective reduced illumination levels of the third color, wherein the number of subframes in the fifth number of subframes is different than the number of subframes in the second number of subframes.

19. A computer readable medium storing computer executable instructions, which when executed, cause a processor to:
display, at a first illumination level of a first color, a first number of at least partially time-weighted subframes of an image frame corresponding to the first color, the first illumination level being a maximum illumination level used for the first color in displaying the image frame;
displaying a second number of at least partially time-weighted subframes of the image frame corresponding to the first color at respective reduced illumination levels of the first color;
displaying a third number of at least partially time-weighted subframes of the image frame corresponding to a second color at a third illumination level of the second color, the third illumination level being a maximum illumination level used for the second color in displaying the image frame; and
displaying a fourth number of at least partially time-weighted subframes of the image frame corresponding to the second color at respective reduced illumination levels of the second color, wherein the number of subframes in the fourth number of subframes is different than the number of subframes in the second number of subframes.

20. The computer readable medium of claim 19, wherein the first color and second color correspond to colors of first and second subfields of an image frame, and the first number and second number of subframes include subframes generated for the first subfield of the image frame and the third number and fourth number of subframes include subframes generated for the second subfield of the image frame.

21. The computer readable medium of claim 20, wherein the second color corresponds to a frame specific contributing color subfield.

22. The computer readable medium of claim 19, wherein at least one of the subframes in the first number of subframes is illuminated for a period of time that is shorter than the amount of time it takes to load data corresponding to the at least one subframe into an array of light modulators used to display the at least one subframe.
